(19) United States
(12) Patent Application Publication
(10) Pub. No.: US 2008/0252180 A1
(43) Pub. Date: Oct. 16, 2008

(54) Electricity Generating Playground Equipment and Method

(76) Inventor: Ben Stephen Markham, Provo, UT (US)

Correspondence Address: THORPE NORTH & WESTERN, LLP., P.O. Box 1219, SANDY, UT, 84091-1219, US

(21) Appl. No.: 12/060,785

(22) Filed: Apr. 1, 2008

Related U.S. Application Data
(60) Provisional application No. 60/921,638, filed on Apr. 2, 2007.

(51) Int. Cl. H02K 7/00; A63G 1/12

(52) U.S. Cl. 310/40 R; 472/14

(57) ABSTRACT

An electricity generating playground device configured for recreational activity by children includes a playground device having a cyclically movable part. An electricity generator is operably coupled to the cyclically movable part, and operable to generate electricity when the cyclically movable part is moved through a cyclical motion. A duty cycle controller is operably coupled to the electricity generator, and operable to convert a predetermined portion of the kinetic energy of the cyclically movable part to usable electricity.

### PRIORITY CLAIM

Benefit is claimed of U.S. Provisional Patent Application No. 60/921,638, filed Apr. 2, 2007, which is herein incorporated by reference in its entirety for all purposes.

### BACKGROUND OF THE INVENTION

1. Field of the Invention

The present invention relates generally to playground equipment.

2. Related Art

It has been demonstrated that improving educational systems and opportunities has unparalleled influence in improving the well being of communities and societies. Though most education occurs within families and households, much of the knowledge required to assist individuals to be successful in their society is formally obtained in schools.

Unfortunately, formal education in many developing countries is severely limited by depressed economic conditions. For example, while formal education is often required by law in many developing countries, the national governments provide little financial support for such education, and poverty stricken local communities must bear the full cost of educating their children. As a result, in many rural, economically depressed areas, schools are constructed of mud adobe type materials with few or no windows, and no modern amenities such as plumbing and electricity. Since these schools do not have electrical power, they are not equipped with electrical lighting, and students and teachers must rely on natural light which is inadequate due to lack of windows in the school structure and which is only available during daylight hours.

Providing electrical power to these schools would greatly enhance the ability to provide formal education to the children of these developing nations. However, the financial and natural resources simply are too scarce in many of these developing nations to provide usable power to these communities. Alternate resources such as manpower and labor resources can often be found in greater abundance, but tapping into available human resources to provide electrical power has only had limited success.

Some such attempts have tried to harness the energy of children at play. It has been recognized that large groups of children in a playground can collectively generate hundreds of watts of power on the playground equipment, such as merry-go-rounds, teeter totters, swings, and the like. Some attempts to tap into this kid-power, unfortunately, these attempts have been less successful because extracting sufficient energy from play devices to charge a deep cycle battery has made the playground devices difficult to operate due to drag on the playground device from the electrical generating equipment. Additionally, gear transmissions on cyclical or rotary equipment often have to be nearly perfectly aligned, thereby causing the power generating equipment to be very expensive to purchase, install and maintain.

### SUMMARY OF THE INVENTION

The inventor of the present invention has recognized that it would be advantageous to develop a method for producing and storing electricity to power lights in schools and homes that are not connected to a power grid. Additionally, the inventor has recognized that it would be advantageous to develop a method and device for generating a usable amount of electricity from a cyclical or reciprocal playground device while minimizing undesirable drag on the playground device. Additionally, the inventor has recognized that it would be advantageous to develop a method and device for generating a usable amount of electricity from rotary playground devices that allow for off centering and wobble of the rotary playground device with respect to the electrical generator.

The invention provides an electricity generating playground device configured for recreational activity by children. The playground device can include a playground device having a cyclically movable part. An electricity generator can be operably coupled to the cyclically movable part, and operable to generate electricity when the cyclically movable part is moved through a cyclical motion. A duty cycle controller can be operably coupled to the electricity generator, and operable to convert a predetermined portion of the kinetic energy of the cyclically movable part to usable electricity.

In accordance with a more detailed aspect of the present invention, the playground device can include a merry-go-round with a double bearing shaft coupled to a post at each of a pair of spaced apart bearings. The spaced apart bearings can be sufficiently spaced apart from one another to minimize wobble of the merry-go-round on the merry-go-round engagement end of the double bearing shaft.

Additionally, a reverse helical gear box can be coupled to the double bearing shaft and the electricity generator. The reverse helical gear box can include a reverse helical gear that can transmit and increase the rotational speed from the double bearing shaft to the electrical generator.

In accordance with another aspect, the present invention can include a zip line with a launch tower having a relatively larger rotatable pulley coupled to a relatively taller framework fixedly disposed in a ground surface, and a landing tower having a relatively smaller rotatable pulley coupled to a relatively shorter framework fixedly disposed in a ground surface. A line can be operably disposed on the relatively larger pulley and extend to the relatively smaller pulley. The line can rotate the relatively large pulley and the relatively smaller pulley when a load, such as a child, is suspended on the line at the launch tower. The electricity generator and the duty cycle controller can be operatively coupled to the relatively smaller pulley.

The present invention also provides a method for providing electrical lighting to a school or home located in a remote location and inaccessible to an electrical power grid. The method can include generating electricity from an electricity generating playground device. The electricity generated by the playground device can be stored in a battery. A plurality of portable lighting devices can be charged in a charging station that can be electrically coupled to the battery to draw power from the battery to charge the portable lighting devices. The charging station can be disposed in the school or home. The portable lighting devices can be turned on in order to illuminate the school or home.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a schematic view of an electricity generating playground device in accordance with an embodiment of the present invention;

FIG. 2 is a perspective view of an electricity generating playground device in accordance with another embodiment of the present invention including a merry-go-round;

FIG. 3 is a perspective view of the playground device of FIG. 2, shown with portions of a rotatable deck removed and access panels to an electricity generator removed; and

FIG. 4 is a fragmentary perspective view of the playground device of FIG. 2;

FIG. 5 is a fragmentary perspective view of the playground device of FIG. 2, showing a double bearing shaft, a reverse helical gear, and an electricity generator coupled to a rotatable deck;

FIG. 6 is a fragmentary perspective view of the playground device of FIG. 2, showing a double bearing shaft, a reverse helical gear, and an electricity generator coupled to a rotatable deck;

FIG. 7 is a fragmentary front view of the playground device of FIG. 2, showing a double bearing shaft, a reverse helical gear, and an electricity generator coupled to a rotatable deck and a post;

FIG. 8 is a perspective view of the framework of the merry-go-round of FIG. 2;

FIG. 9 is a bottom view of the framework of FIG. 8;

FIG. 10 is a fragmentary perspective view of the frame work of FIG. 8;

FIG. 11 is a fragmentary perspective view of the playground device of FIG. 2, showing a double bearing shaft, a reverse helical gear, and an electricity generator coupled to a rotatable deck;

FIG. 12 is a fragmentary perspective view of the playground device of FIG. 2, showing a double bearing shaft, a reverse helical gear, and an electricity generator coupled to a rotatable deck;

FIG. 13 is a perspective view of an electricity generating playground device in accordance with another embodiment of the present invention including a zip line; and

FIG. 14 is a fragmentary perspective view of the playground device of FIG. 13.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The embodiments of the present invention described herein provide generally for a playground device, such as a merry-go-round, zip line, teeter totter, and the like, that can generate electricity while children are playing on the device. The electricity generating playground device can have a component that moves in a cyclical, rotational, or reciprocal motion. The cyclically movable component can be coupled to a generator such that when the component moves in a cycle, the component drives the generator and generates electricity. A duty cycle controller can be coupled to the generator to regulate the voltage and control the current generated by the generator. The duty cycle controller can regulate the operation of the generator in order to allow the generator to convert a portion of the kinetic energy of the children playing on the playground device while allowing the remaining kinetic energy to operate the playground equipment in a playful manner. In this way, the playground equipment can remain a fun and safe device to play on instead of becoming a work wheel or treadmill that is not fun to play on.

In another aspect, the embodiments described herein provide for a method for providing electricity to a school or home that is remotely located and inaccessible to an electric power grid. The method can include installing an electricity generating playground device in a playground. A battery can be electrically coupled to the playground device to store electricity generated by children playing on the device. A charging station can be coupled to the battery and a plurality of rechargeable portable electric lights can be charged in the charging station. The portable lights can be checked out of the charging station at the school and taken home by students at night to provide light in the student's home.

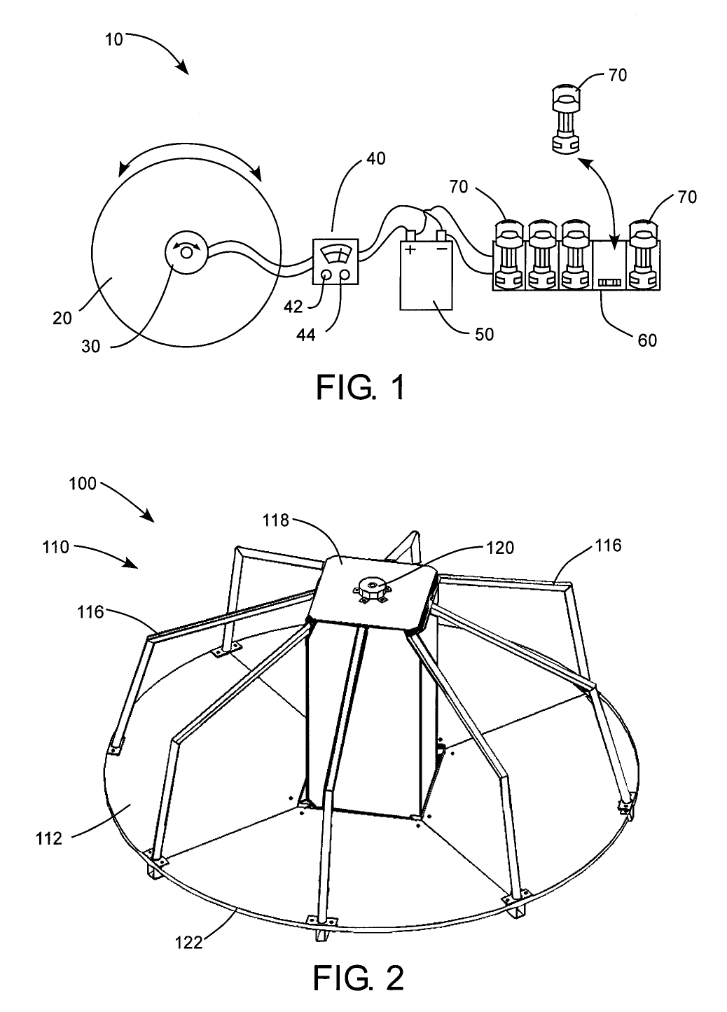

As illustrated in FIG. 1, an electricity generating playground device, indicated generally at 10, is shown in accordance with the present invention for generating electricity when children play on the playground device. The playground device 10 can be a merry-go-round, a teeter totter, a zip line, a witches hat, a pedal car, a windmill, a ratcheting spin sled, a whirly bird, a spring horse, a tire swing, a climbing wall, a bicycle, a treadmill, and the like. Additionally, the playground device 10 can have a cyclically movable part 20, an electricity generator 30, and a duty cycle controller, indicated generally at 40.

The cyclically movable part 20 can be moved in reciprocal or repetitive cycle by children playing on the playground device 10. For example, in the case of a merry-go-round, the cyclically movable part can be a rotatable upper deck that can be turned by children pushing on the deck. Additionally, in the case of a zip line, the cyclically movable part can be pulley that can have a line wrapped around the pulley so that when children travel downward on the line the line rotates the pulley. As another example, in the case of a teeter totter the cyclically movable part can be a ratcheted pivot that ratchets forward and rearward as the children push the teeter totter up and down.

The electrical generator 30 can be operably coupled to the cyclically movable part 20. The generator 30 can be operated by the cyclically movable part 20 so as to generate electricity when the cyclically movable part is moved through a repetitive motion. In one aspect, the generator 30 can be a permanent magnet generator and alternator that can have a low start up speed due to low cogging and resistive torque design. Additionally, the generator can be a gearless, direct drive, and low RPM generator, as known in the art.

The duty cycle controller 40 can be operably coupled to the electricity generator 30. The duty cycle controller 40 can convert a predetermined portion of the kinetic energy of the cyclically movable part 20 to usable electricity. The duty cycle controller 40 can include a voltage regulator 42 that can regulate the voltage of electricity generated by the generator 30. It will be appreciated that a consistent, regulated input voltage is optimal for charging a battery, and the voltage regulator 42 of the duty cycle controller 40 can regulate the voltage for battery charging needs. Additionally, the duty cycle controller 40 can include a pulse width modulator 44 coupled to the generator 30. The pulse width modulator 44 can be programmable to control electrical current flow of the electricity generated by the generator 30. In one aspect, the pulse width modulator 44 of the duty cycle controller 40 can limit current generation to convert approximately ¼, or 25% of the kinetic energy of the cyclically movable part 20 to usable electricity.

The playground device 10 can also include a battery 50 electrically coupled to the electricity generator 30. The battery 50 can receive and store electricity from the electricity generator 30. In one aspect, the battery 50 can be a 12 V lead acid battery, or a deep cycle RV or marine battery. In another aspect, the battery 50 can be a rechargeable valve regulated lead-acid battery with a gelified electrolyte. Other batteries, as known in the art can also be used, so long as the battery is rechargeable.

It will be appreciated that as children play on the electricity generating playground device 10, the children can move the cyclically movable part 20 in uneven and irregular cycles in a given unit of time. This can cause an irregular output from the generator 30 which can cause less than ideal conditions for charging a battery 50. Additionally, as the activity level on the playground device 10 ebbs and flows, the frequency of complete cycling of the cyclically movable part 20 can fall below a minimum threshold for generating power from the generator 30 in which case the drag from the generator 30 can cause the cyclically movable part 20 to stop cycling or become difficult to move. Moreover, in an effort to generate as much electricity as possible from the play of the children on the playground device 10, the generator 30 can cause drag on the playground device that significantly dampens the free cycling or momentum driven cycling of the cyclically movable part 20 making the cyclically movable part difficult to move.

These problems can cause children or adult supervisors to lose interest in the playground device 10. For example, if the playground device is inefficient at producing electricity, adults supervisors may not view the device as anything more than a toy. Additionally, if the cyclically movable part 20 is difficult to move, children may view the playground device as a work tool instead of a toy, and, thus, choose to decrease energy expenditure on the device.

Advantageously, the duty cycle controller 40 can provide solutions to these problems. For example, the voltage regulator 42 of the duty cycle controller 40 can regulate the voltage to the correct level for recharging the battery 50. Additionally, the pulse width modulator 44 of the duty cycle controller 40 can limit the current generated by the generator 30 in order to limit the amount of kinetic energy from the cyclically movable part 20 that is converted to electricity. Thus, the duty cycle controller 40 can be programmed or set to limit the electrical current generation to a level approximately equal to about 25% of the kinetic energy expended by children playing on the playground device 10. The inventors have found that by limiting the amount of current generated by the generator 30 to about 25% of the kinetic energy of children playing on the playground device allows for adequate electricity generation to charge the batteries 50 and does not induce so much drag or dampening on the playground device that operation of the cyclically movable part turns from fun to work for the children playing on the device.

The playground device 10 can also include a charging station 60 that can be electrically coupled to the battery 50. A portable lighting device 70 can be removably coupleable to the charging station 60 in order to charge the lighting device 70 when the lighting device is stowed in the charging station 60. The portable lighting device 70 can be removed from the charging station 60 and carried to a remote location away from the charging station in order to provide light to the remote location.

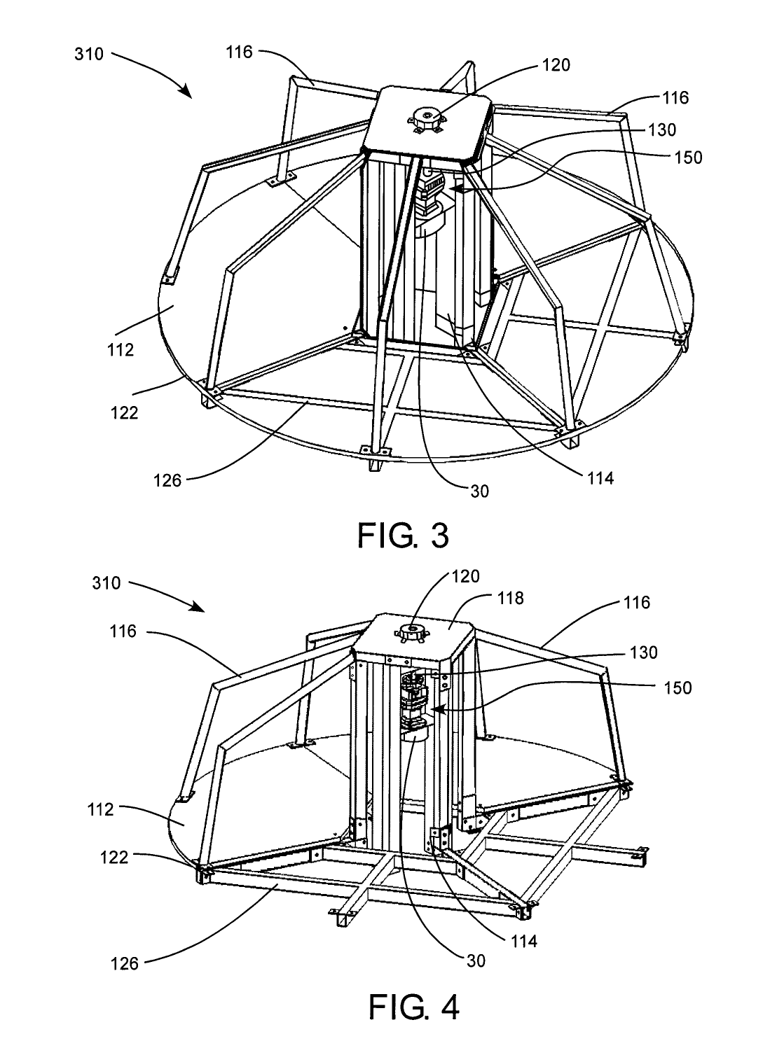

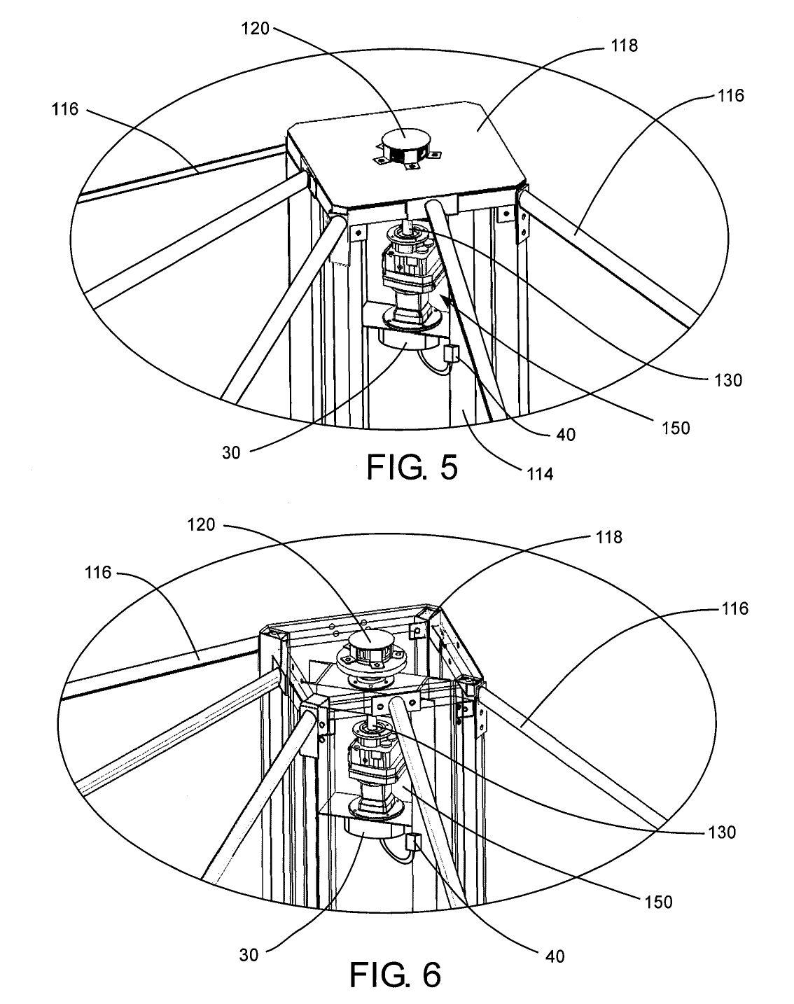

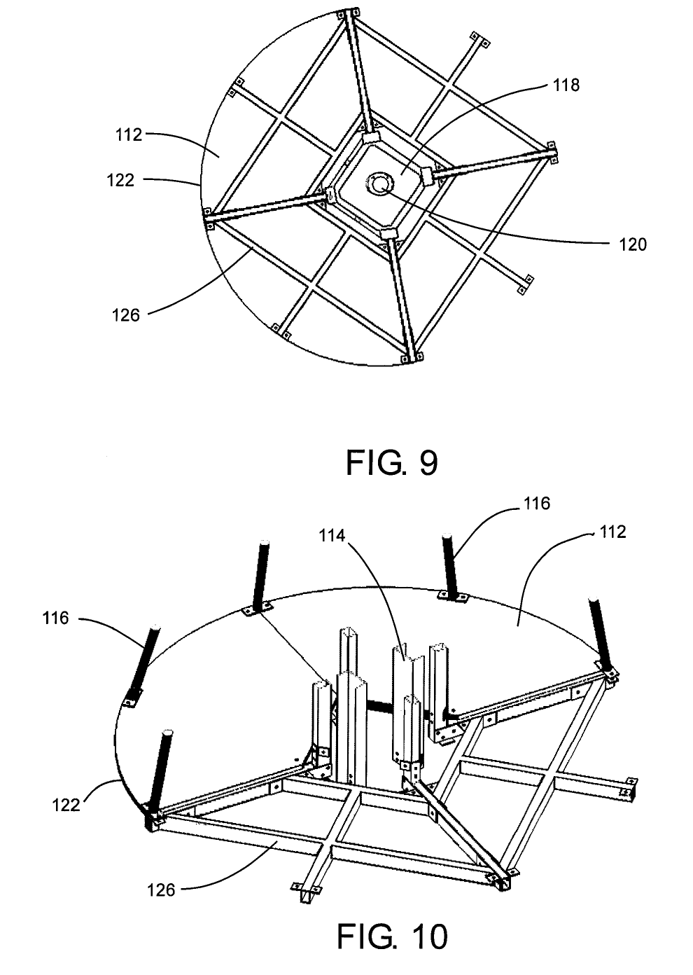

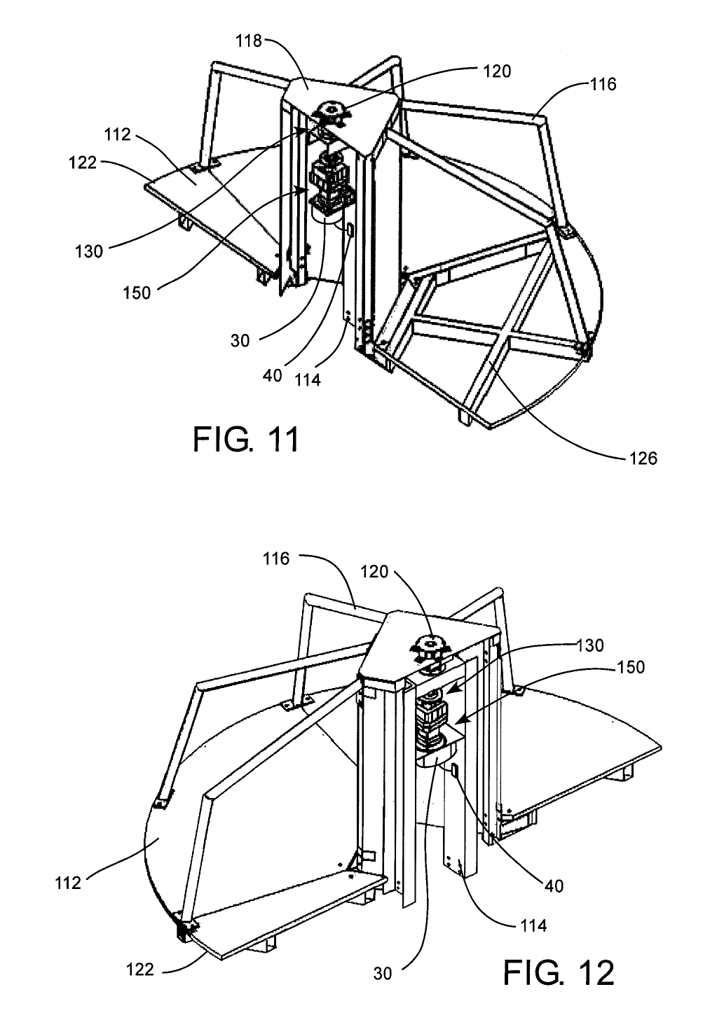

As illustrated in FIGS. 2-12, an electricity generating playground device, indicated generally at 100, is shown in accordance with another embodiment of the present invention for use in recreational activity by children. The playground device 100 can be similar in many respects to the playground device 10 described above and shown in FIG. 1. The playground device 100 can have an electrical generator 30, and a duty cycle controller 40.

Additionally, the playground device can include a merry-go-round, indicated generally at 110, with a rotatable deck 112 rotatably disposed on a post 114 that can be fixedly positioned in a ground surface (not shown). A frame 126 can support the rotatable deck 112. A plurality of handles 116 can extend from a center stanchion 118 to the rotatable deck 112. The merry-go-round 110 can also include a double bearing shaft, indicated generally at 130, and a reverse helical gear box, indicated generally at 150.

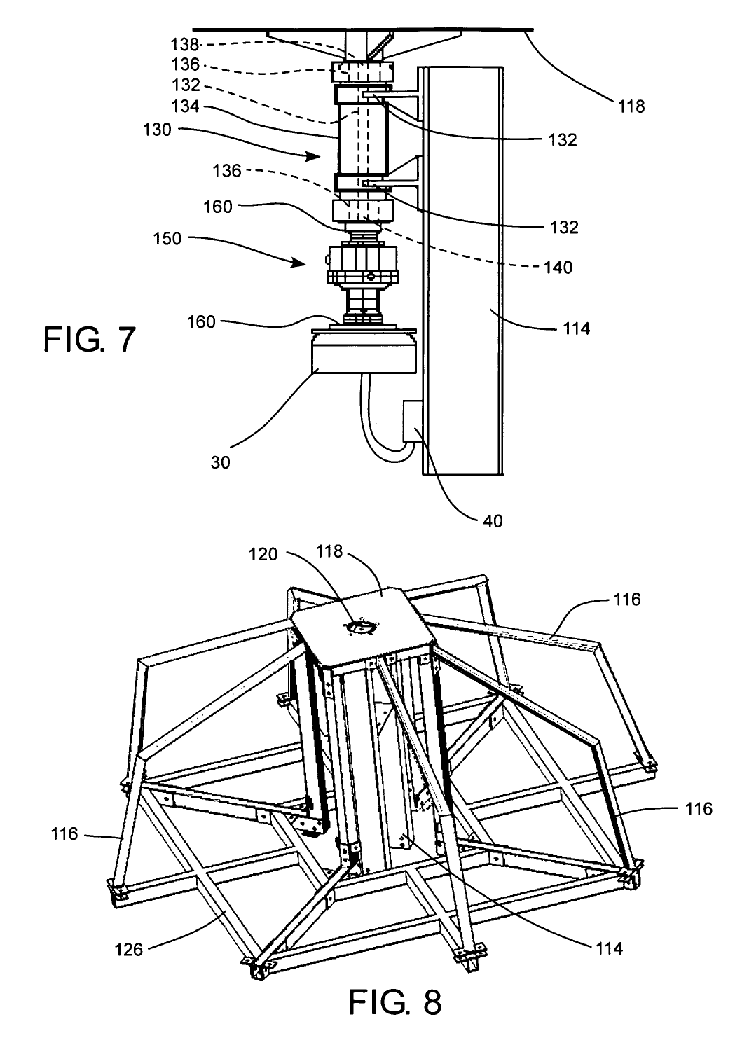

As best seen in FIG. 7, the double bearing shaft 130 can have a shaft 132 disposed in a shaft housing 134 with tapered roller bearings 136 seated at either end of the shaft housing 134. The shaft housing 134 can be coupled to the post 114 at each of a pair of spaced apart couplings 132. The couplings 132 can be sufficiently spaced apart from one another to stabilize the shaft 130 in order to restrict non-axial movement of the shaft. In this way, the double bearing shaft 130 can minimize the effects of wobble of the rotatable deck 112 on the engagement end 134 of the double bearing shaft 130.

The shaft 132 can have an engagement end 138 rotatably coupled to an approximate rotational center 120 of the rotatable deck 112. The shaft 132 can be rotatable with the rotatable deck 112. The bearings 136 can be located at each end of the shaft housing 138 such that the pair of bearings 136 are spaced apart in relation to one another.

Returning to FIGS. 2-12, it will be appreciated that while the rotatable deck 112 of the merry-go-round 110 is carried and supported by the shaft 132 of the double bearing shaft 130 at an approximate rotational center 120 of the rotatable deck 112, children pushing, pulling, and playing on the rotatable deck 112 will often apply loads on an outer edge 122 of the rotatable deck 112. These loads can be amplified on the double bearing shaft 130 because the distance between the edge 122 of the rotatable deck 112 and the double bearing shaft 130 can act as a moment arm. Thus, the loads on the edge 122 of the rotatable deck 112 can act to twist or turn the shaft 130 in the direction of the load. Advantageously, the pair of spaced apart couplings 136 and the spaced apart bearings 136 of the double bearing shaft 130 can act to stabilize the shaft and minimize non-axial rotation or turning of the shaft in response to the loads applied to the rotatable deck 112.

The reverse helical gear box 150 can be coupled to the transmission end 140 of the double bearing shaft 130. The transmission end 140 of the double bearing shaft 130 can be an opposite end from the engagement end 138 of the shaft. The reverse helical gear box 150 can include a reverse helical gear (not shown). The reverse helical gear can be sized and shaped to transmit and increase the rotational speed from the double bearing shaft 130 to the electricity generator 30. In one aspect, the reverse helical gear can be sized and shaped to provide approximately a 30:1 step up between the rotation of the double bearing shaft 130 and the electrical generator 30. In this way the reverse helical gear box 150 can act as a transmission for the playground device 100 to step up or step down the RPMs transmitted from the playground device 100 to the generator 30.

It will be appreciated that the reverse helical gear box 150 can be a gear box with a helical gear system placed into the gear box in such a way as to increase speed or rpm from the input shaft to the output shaft, as described above. Additionally, in another aspect, the reverse helical gear box 150 can be a normal multiple stage helical gear box that is installed and driven backward. In this case the merry-go-round can be coupled to the normal output shaft and the generator can be coupled to the normal input shaft. In this way, the normal multiple stage helical gear box can function as a speed increaser that steps up the rpm instead of a speed reducer which is the typical service of a multiple stage helical gear box. In either case, the helical gear box 150 can step up the relatively low rpm's from the merry-go-round 310 to relatively high rpm's needed to run the electricity generator 10.

As best seen in FIG. 7, a pair of flexible couplings 160 can be disposed on either side of the gearbox 150. The flexible couplings 160 can interface with the double bearing shaft 130 and the electricity generator 30. The flexible couplings 160 can flex in response to loading on the rotatable deck 112 that may transfer through the double bearing shaft 130 so as to provide some additional cushion or shock absorption from non-axial forces applied to the reverse helical gear box 150 by children playing on the rotatable deck 112. Thus, one of the flexible couplings 160 can be disposed between the double bearing shaft 130 and the reverse helical gear box 150, and the other flexible coupling 160 can be disposed between the reverse helical gear box 150 and the electricity generator 30. The pair of flexible couplings 160 can be flexible to cushion non rotational motion of the merry-go-round 110 with respect to the reverse helical gear box 150.

The flexible couplings 160 allow the reverse helical gear box 150 some slight self centering during operation with respect to the double bearing shaft 130 and the electricity generator 30. This self centering ability provides several advantages to the playground device 10. For example, the self centering ability of the reverse helical gear box 150 can reduce the installation time of the electricity generating playground device 10 since the transmission gears of the reverse helical gear box 150 do not need to be precisely aligned with the other rotatable shafts of the double bearing shaft 130 and the generator 30. Additionally, the self centering ability of the reverse helical gear box 150 allows the installation of the playground device in remote rural areas that may not have access to extremely precise leveling and aligning equipment. Moreover, the self centering ability facilitates maintenance of the playground device 10 since the gearbox 150 can be removed and replaced during servicing without the need for precise relocation of the transmission gears.

The electricity generator 30 can be operably coupled to the reverse helical gear box 150. The generator 30 can be operable by the reverse helical gear to generate electricity when the reverse helical gear is rotated by the double bearing shaft 130.

The duty cycle controller 40 can be operably coupled to the electricity generator 30. The duty cycle controller 40 can be operable to convert a predetermined portion of the kinetic energy of the rotatable deck 112 to usable electricity.

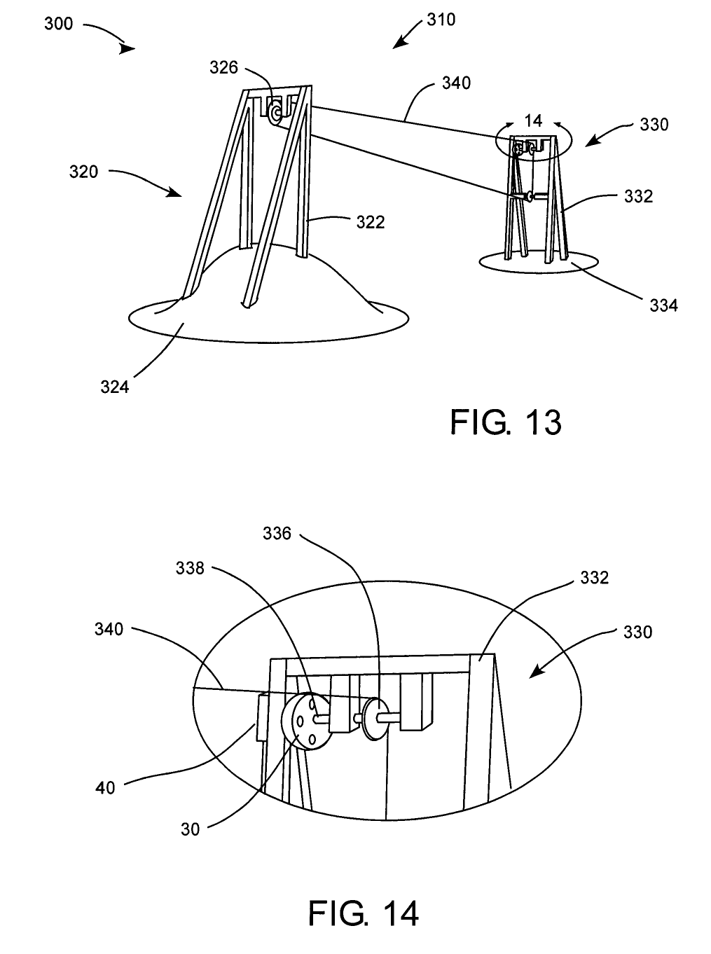

As illustrated in FIGS. 13 and 14, an electricity generating playground device, indicated generally at 300, is shown in accordance with another embodiment of the present invention for use in recreational activity by children. The playground device 300 can be similar in many respects to the playground device 10 described above and shown in FIG. 1. The playground device 300 can have an electrical generator 30, and a duty cycle controller 40.

Additionally, the playground device 300 can include a zip line 310 on which a user can travel from a relatively higher location to a relatively lower location. The zip line 310 can include a launch tower, indicated generally at 320, a landing tower, indicated generally at 330, and a line 340 extending between the launch tower 320 and the landing tower 330.

The launch tower 320 can have a relatively taller framework 322 fixedly disposed in a ground surface 324. A rotatable pulley 326 can be coupled to the taller framework 324.

Similarly, the landing tower 330 can have a relatively shorter framework 332 fixedly disposed in a ground surface 334. The shorter framework 332 can be spaced away from the launch tower 320 by a desired distance. A rotatable pulley 336 can be coupled to the shorter framework 332.

The line 340 can operably extend between the relatively larger pulley 326 and the relatively smaller pulley 336. The line 340 can be continuous and can extend around the pulleys. The line 340 can have sufficient tension between the pulleys 326 and 336 to frictionally grip and rotate the pulleys when a user, such as a child, is suspended on the line 340 and travels from the launch tower 320 toward the landing tower 330 on the line 340.

The relatively taller framework 322 of the launch tower 320 can be sufficiently taller than the relatively shorter framework 332 of the landing tower 330 so as to ensure sufficient descent speed of the user on the line 340 in order to rotate the pulley 336 on the landing tower 330 with a sufficient rotational velocity to cause the generator 30 to produce electricity. Thus, in one aspect, the height of the launch tower 320 can be approximately 8 feet from the ground surface 324 and the height of the landing tower 330 can be approximately 5 feet from the ground surface 334 such that the change in height between the landing tower and the launch tower is approximately 3 feet.

The electricity generator 30 can be operably coupled to the landing tower pulley 336 so as to be directly driven by the rotation of the landing tower pulley. A common shaft 338 can couple the pulley 336 to the generator 30. The shaft 338 can be rotatable by the pulley 336 and can in turn operate the generator 30 to generate electricity. Advantageously, the inventors have found that with a sufficient height difference between the launch tower 320 and the landing tower 330, gear reduction or step up are not needed to drive the generator 30. Thus, the generator 30 can generate electricity when the landing tower pulley 336 is rotated by the line 340 as a user descends from the launch tower to the landing tower on the line.

The duty cycle controller 40 can be operably coupled to the electricity generator 30. The duty cycle controller 40 can be operable to convert a predetermined portion of the kinetic energy of the landing tower pulley 336 to usable electricity.

The present invention also provides a method for providing electrical lighting to a school or home located in a remote location and inaccessible to an electrical power grid. The method can include generating electricity from an electricity generating playground device such as the playground device 10 described above and shown in FIG. 1, the merry-go-round 100 described above and shown in FIGS. 2-12, or the zip line 300 described above and shown in FIGS. 13-14. The electricity generated by the playground device can be stored in a battery. A plurality of portable lighting devices can be charged in a charging station that can be electrically coupled to the battery to draw power from the battery to charge the portable lighting devices. The charging station can be disposed in the school or home. The portable lighting devices can be turned on in order to illuminate the school or home.

The method can also include removing at least one of the plurality of portable lighting devices from the charging station and moving the portable lighting device to a remote location away from the charging station in order to illuminate the remote location.

When the charging station and the electricity generating playground device are associated with a school, the method can also include checking out at least one of the portable lighting devices to a student in the class. The student can be sent home with the portable lighting device in order to provide light at a dwelling away from the school.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

What is claimed:

1. An electricity generating playground device, configured for recreational activity by children, comprising:
a) a playground device having a cyclically movable part;
b) an electricity generator operably coupled to the cyclically movable part, and operable to generate electricity when the cyclically movable part is moved through a cyclical motion; and
c) a duty cycle controller operably coupled to the electricity generator, and operable to convert a predetermined portion of the kinetic energy of the cyclically movable part to usable electricity.

2. The device of claim 1, wherein the playground device is selected from the group consisting of a merry-go-round, a teeter totter, a zip line, a witches hat, a pedal car, a windmill, a ratcheting spin sled, a whirly bird, a spring horse, a tire swing, a climbing wall, a bicycle, a treadmill, and combinations thereof.

3. The device of claim 1, wherein the playground device is a merry-go-round, and further comprising:
a) a post configured to be fixedly positioned in a ground surface;
b) a double bearing shaft coupled to the post at each of a pair of spaced apart bearings, the double bearing shaft having a merry-go-round engagement end rotatably coupled to the merry-go-round and rotatable therewith, and the couplings at each of the pair of spaced apart bearings being sufficiently spaced apart from one another to minimize wobble of the merry-go-round on the merry-go-round engagement end of the double bearing shaft;
c) a reverse helical gear box coupled to a transmission end of the double bearing shaft and the electricity generator, the reverse helical gear box including a reverse helical gear sized and shaped to transmit and increase the rotational speed from the double bearing shaft to a shaft of the electrical generator.

4. The device of claim 3, further comprising:
a) a pair of flexible couplings with one flexible coupling disposed on the merry-go-round engagement end of the double bearing shaft and one flexible coupling disposed on the transmission end of the double bearing shaft, the pair of flexible couplings being flexible to cushion non rotational motion of the merry-go-round with respect to the double bearing shaft.

5. The device of claim 3, wherein the reverse helical gear is sized and shaped to provide approximately a 30:1 step up between the rotation of the double bearing shaft and the electrical generator.

6. The device of claim 1, wherein the playground device is a zip line, and further comprising:
a) a launch tower having a rotatable pulley coupled to a relatively taller framework fixedly disposed in a ground surface;
b) a landing tower having a rotatable pulley coupled to a relatively shorter framework fixedly disposed in a ground surface and spaced a predetermined distance away from the launch tower;
c) a line operably extending between the pulleys and operable to rotate the pulleys when a user is suspended on the line and travels from the launch tower toward the landing tower on the line; and
d) the electricity generator and the duty cycle controller being operatively coupled to the pulley on the landing tower, the electricity generator being operable by the rotation of the pulley on the landing tower.

7. The device of claim 1, wherein the duty cycle controller includes:
a) a voltage regulator configured to regulate the voltage of electrical current generated by the generator; and
b) a pulse width modulator configured to control the amount of current generated by the generator.

8. The device of claim 1, wherein the duty cycle controller regulates the voltage and current to convert approximately ¼ of the kinetic energy of the cyclically movable part to usable electricity.

9. The device of claim 1, further comprising:
a) a battery electrically coupled to the electricity generator and configured to receive and store electricity from the electricity generator.

10. The device of claim 9, further comprising:
a) a charging station electrically coupled to the battery; and
b) a portable lighting device removably coupleable to the charging station to charge the lighting device when the lighting device is coupled to the charging station and to provide light to a remote location away from the charging station when the lighting device is removed from the charging station.

11. An electricity generating playground device, configured for recreational activity by children, comprising:
a) a merry-go-round having a rotatable deck rotatably disposed on a post configured to be fixedly positioned in a ground surface, the merry-go-round further comprising:
i) a double bearing shaft coupled to the post at each of a pair of spaced apart bearings, the double bearing shaft having an engagement end rotatably coupled to the rotatable deck and rotatable therewith, and the couplings at each of the pair of spaced apart bearings being sufficiently spaced apart from one another to minimize wobble of the rotatable deck on the engagement end of the double bearing shaft; and
ii) a reverse helical gear box coupled to a transmission end of the double bearing shaft, the reverse helical gear box including a reverse helical gear sized and shaped to transmit and increase the rotational speed from the double bearing shaft;
b) an electricity generator operably coupled to the reverse helical gear, and operable to generate electricity when the reverse helical gear is rotated by the double bearing shaft; and
c) a duty cycle controller operably coupled to the electricity generator, and operable to convert a predetermined portion of the kinetic energy of the rotatable deck to usable electricity.

12. The device of claim 11, further comprising:
a) a pair of flexible couplings with one flexible coupling disposed on the engagement end of the double bearing shaft and one flexible coupling disposed on the transmission end of the double bearing shaft, the pair of flexible couplings being flexible to cushion non rotational motion of the rotatable deck with respect to the double bearing shaft.

13. The device of claim 11, wherein the reverse helical gear is sized and shaped to provide approximately a 30:1 step up between the rotation of the double bearing shaft and the electrical generator.

14. The device of claim 11, wherein the duty cycle controller includes:
a) a voltage regulator configured to regulate the voltage of electrical current generated by the generator; and
b) a pulse width modulator configured to control the amount of current generated by the generator.

15. The device of claim 11, wherein the duty cycle controller regulates the voltage and current to convert approximately ¼ of the kinetic energy of the cyclically movable part to usable electricity.

16. An electricity generating playground device, configured for recreational activity by children, comprising:
a) a zip line configured to allow a user to travel from a relatively higher location to a relatively lower location, the zip line further comprising:
i) a launch tower having a rotatable pulley coupled to a relatively taller framework fixedly disposed in a ground surface;
ii) a landing tower having a rotatable pulley coupled to a relatively shorter framework fixedly disposed in a ground surface and spaced a predetermined distance away from the launch tower;
iii) a line operably extending between the pulleys and operable to rotate the pulleys when the user is suspended on the line and travels from the launch tower toward the landing tower on the line; and
b) an electricity generator operably coupled to the pulley on the landing tower, and operable to generate electricity when the pulley on the landing tower is rotated by the line; and
c) a duty cycle controller operably coupled to the electricity generator, and operable to convert a predetermined portion of the kinetic energy of the pulley on the landing tower to usable electricity.

17. The device of claim 16, wherein the duty cycle controller includes:
a) a voltage regulator configured to regulate the voltage of electrical current generated by the generator; and
b) a pulse width modulator configured to control the amount of current generated by the generator.

18. The device of claim 16, wherein the duty cycle controller regulates the voltage and current to convert approximately ¼ of the kinetic energy of the cyclically movable part to usable electricity.

19. A method for providing electrical lighting to a school located in a remote location and inaccessible to an electrical power grid, comprising:
a) generating electricity from an electricity generating playground device;
b) regulating the voltage and limiting the amount of current generated by the playground device with a duty cycle controller having a voltage regulator and a pulse width modulator;
c) storing the electricity from the playground device in a battery;
d) charging a plurality of portable lighting devices in a charging station electrically coupled to the battery and disposed in the school; and
e) turning on the portable lighting devices to illuminate the school.

20. The method of claim 19, further comprising:
a) removing the plurality of portable lighting devices from the charging station; and
b) moving the portable lighting device to a remote location away from the charging station in order to illuminate the remote location.

21. The method of claim 20, further comprising
a) checking out at least one of the portable lighting devices to a student in the school; and
b) sending the student home with the portable lighting device to provide light at a dwelling away from the school.

22. The method of claim 19, wherein the electricity generating playground device further comprises:
a) a playground device having a cyclically movable part;
b) an electricity generator operably coupled to the cyclically movable part, and operable to generate electricity when the cyclically movable part is moved through a repetitive motion; and
c) a duty cycle controller operably coupled to the electricity generator, and operable to convert a predetermined portion of the kinetic energy of the cyclically movable part to usable electricity.
